(19) United States
(12) Patent Application Publication
(10) Pub. No.: US 2009/0259770 A1
(43) Pub. Date: Oct. 15, 2009

(54) Method and Apparatus for Serializing and Deserializing

(75) Inventors: Charles H. Moore, Sierra City, CA (US); Gregory V. Bailey, Incline Village, NV (US)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/421,921

(22) Filed: Apr. 10, 2009

Related U.S. Application Data
(60) Provisional application No. 61/124,174, filed on Apr. 15, 2008.

(51) Int. Cl. G06F 15/16; H04B 1/38

(52) U.S. Cl. 709/246; 375/219

(57) ABSTRACT

A method and apparatus for serialization of a transmitted data stream and deserialization of data on a single die chip 105, including a plurality of processors 110 on a single chip 105. The processors on the chip 105 are connected by single drop busses 120 and act as individual processors with at least some dedicated memory 118. The method of serializing includes initialization of a register serializing a most significant bit from said register, moving all bits in the direction of the most significant bit, replacing the least significant bit with a value of zero, and continuing said serializing and moving steps are continued until a stopping condition is met. The method of deserialization of a data word includes initializing a register used for deserialization, deserializing a bit, positioning the bit in the least significant bit of the register, moving all bits in the direction of the most significant bit, and continuing the positioning and moving steps until a stopping condition is reached.

### CROSS-REFERENCE TO RELATED APPLICATIONS

This application claims the benefit of U.S. Provisional Patent Application Ser. No. 61/124,174 entitled, “Improvements for a Computer Array Chip”, filed on Apr. 15, 2008, which is incorporated herein by reference in its entirety.

### COPYRIGHT NOTICE AND PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention pertains to a method and apparatus for performing serialization of a transmitted data stream and deserialization of an incoming data stream. In particular, the invention pertains to methods for optimization of a multinode processors used in serialization of a transmitted data stream and deserialization of an incoming data stream.

### BACKGROUND OF THE INVENTION

In conventional digital systems and processing devices, data is typically represented and internally handled in parallel, in the form of computer words or bytes, each containing a number of bits characteristic of the particular system.

Accordingly, there is a need for an improved serialization of a transmitted data stream and deserialization (SERDES) applicable to a parallel distributed array processor system disposed on a single microchip, and that can be implemented therein through software.

### SUMMARY OF THE INVENTION

In an embodiment of the proposed invention, the internal circuits and wires of the system reflect this parallelism and include sets of identical bi-stable circuits, called registers, for holding the data and sets of parallel wires called buses for transferring the data between parts of the system.

Data transfer between systems can be accomplished in the same way, in parallel, by a communication link that includes data wires equal to the number of bits in a byte to be transferred and one additional wire for the clock signal. The controller on one end of the communication link sends either Vₛₛ or V_{dd} for each bit of the byte along the respective data wires, and a clock signal along the clock wire. The controller on the other end of the communication link uses the clock signal to initiate the receiving of the byte and places the individual bits simultaneously on a data bus for storing the byte of data into a local memory register.

However, the wires of a parallel link have slightly different electrical properties, resulting in slightly different transmission delay over a long distance, in the various wires of a parallel communication link. The difference in pulse arrival time can become a significant fraction of pulse width for a high data rate signal, and can result in corrupting the parallel signal. Thus, parallel communication is practical only for extremely short distances at currently employed data rates, and hence it is impractical for communication in most computer networks. On the other hand, serial communication can be employed. Serial communication is the process of sending data one bit at a time sequentially over a communication link. A byte is broken up into its bit components and a clock signal is used to clock each bit from one serial controller to a second serial controller by means of a single wire communication link. The second controller reformulates the byte once all bits have been received.

A processing device that sends data to a second processing device can do so using serial communication. However, the data in each processing device is represented in parallel. Passing the data between processing devices is accomplished by converting the (parallel_data words into a serial stream and sending the second processing device, which converts the serial stream back into parallel data words. A means for performing these two functions of conversion (serial to parallel and parallel to serial) in each direction, at one end of a high speed communication link, is commonly referred to as a Serializer/Deserializer, or SERDES. The present invention is directed to SERDES for a particular type of computer system, one that has a parallel-distributed structure at the hardware level, comprising a plurality of substantially similar hardware portions disposed as an array on a single microchip (also known as a die), employing direct communication between adjacent portions, without a common bus over which to address individual portions on the chip. Generally, each hardware portion includes a set of functional resources that is the smallest repeated element of the array. One known form of such a computer system is a single chip multiprocessor array, comprising a plurality of substantially similar directly-connected computers, each computer having processing capabilities and at least some dedicated memory. Moore, et al., (U.S. Pa. App. Pub. No. 2007/0250682 A1) discloses such a computer system. This design approach has proven advantageous in terms of operating speed, power saving, small size, and ease of programming, especially in real-time embedded control and signal processing environments, which are increasingly important fields of computer application.

While several types of SERDES are known in conventional computer networks and communication systems, these are not well suited for use in parallel-distributed systems such as multi-core (multiprocessor) arrays, especially on a single microchip. Other types of serial interfaces are known in parallel distributed systems and multiprocessor arrays, but the known serial interfaces are slow.

### BRIEF DESCRIPTION OF THE FIGURES

FIG. 1 is a symbolic block diagram of a SERDES machine according to the present invention, in a computer array of processing devices;

FIG. 2 illustrates the major internal features of one of the processing devices of the array of FIG. 1, as implemented by a SEAforth®-40C18 multi-core microprocessor chip sold under the trademark SEAforth®;

FIG. 3 is a flow chart describing the methodology used by the state machine to control the operation of the SERDES for sending serial data according to one embodiment;

FIG. 3a is a flow chart describing the detailed methodology of the state machine to control the operation of the SERDES, in particular the step of transmitting a data word bit by bit according to one embodiment;

FIG. 4 is a flow chart describing the methodology used by the state machine to control operation of the SERDES for receiving serial data according to one embodiment;

FIG. 4a is a flow chart describing the detailed methodology of the state machine to control the operation of the SERDES, in particular, the step of receiving a data word bit by bit according to one embodiment;

FIG. 5a is the native machine language and compiler directives written to instruct a processing device on the SEAforth® S40 array of processing devices for serializing data words according to one embodiment;

FIG. 5b is the native machine language and compiler directives written to instruct a processing device on the SEAforth® S40 array of processing for deserializing data words according to one embodiment;

FIG. 6a illustrates several views of the state of the register used by the SERDES for serializing a data word according to one embodiment;

FIG. 6b illustrates several views of the state of the register used by the SERDES for deserializing a data word according to one embodiment;

### DETAILED DESCRIPTION OF THE FIGURES

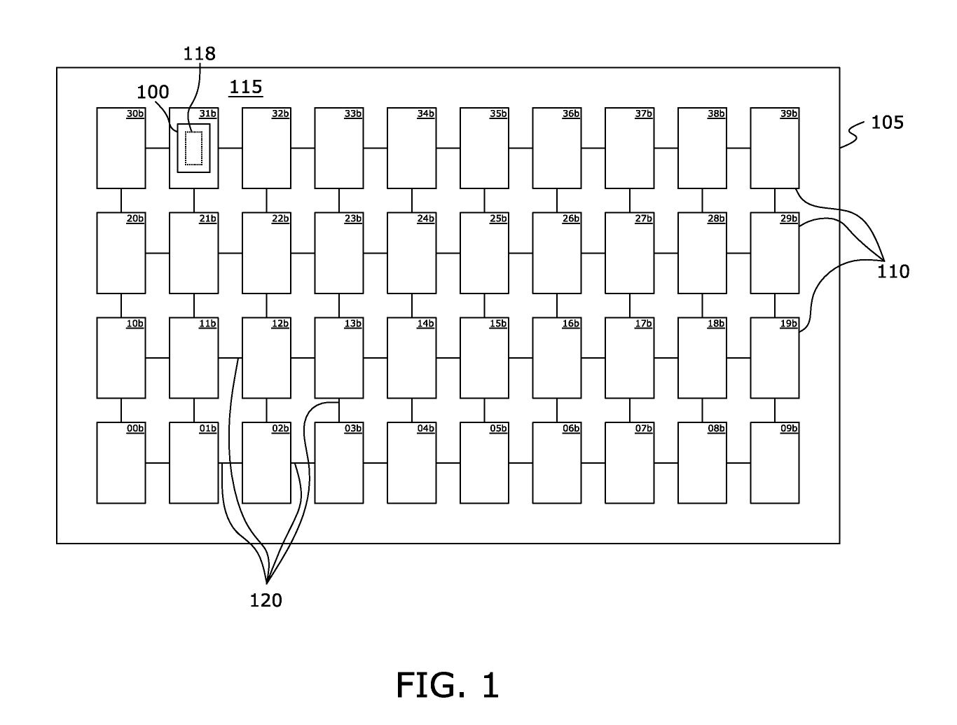

The inventive SERDES machine is depicted in block diagram and symbolic view in FIG. 1, and is designated therein by the general reference character 100. According to this embodiment of the invention, the SERDES machine 100 is a computer 110 that is one of a plurality of substantially similar computers 110 (sometimes also referred to as processors, cores or nodes) located on a single microchip 115, and is executing a program of instructions, herein referred to as SERDES 118. The plurality of computers comprising an array 105 of computers are interconnected and adapted to operate as a multiprocessor computer system. In some cases, depending on the application, all the computers may not be substantially similar and some of the computers in array 105 can have additional or different circuit portions compared to other computers, for example, a computer on the periphery of the chip can have a circuit portion adapted to communication with devices external to the chip, through an I/O port, however, other purposes for such different circuit portions can also exist. The SERDES machine 100, by executing the SERDES program 118, thereby collects and transmits back serial information through an I/O port. The SERDES machine 100 is connected to a serial transmission link 119 for communicating with an external device or system.

In one embodiment of the invention, adjacent, neighboring computers 110 can be directly connected to each other along individual single-drop buses 120, as illustrated in FIG. 1, and can operate asynchronously, both internally and for communicating with each other and external devices. According to an embodiment of the invention, a single-chip SEAforth®-40C18 Embedded Array Processors can serve as array 105. Computers 110 of such a processor array, sometimes also referred to as C18 cores, employs a dual-stack design with one “data stack” and one “return stack”, 18-bit word size, have individual ROM and RAM memory, and are adapted to execute native (machine) FORTH language instructions and to use FORTH words (also known as subroutines and programs), dictionaries of FORTH words, and forthlets, sometimes collectively referred to as “FORTH code”. These and other aspects, and operations of such a processor array, are described by Moore, in publicly available material.

FIG. 1 is a diagrammatic view of a computer array 105 having a plurality (forty in the example shown) of computers sometimes also referred to as “cores” or “nodes” in single module or single semiconductors die implementations. The array 105 is used in an embodiment. The computers 110 can be referred to herein also as C18 computers and individually designated by a reference numeral (00b-39b) appearing in the upper right corner of the symbolic block representing each computer in the figure. For example, the C18 computer located in the top right of the die 115 is referred to as node 39b or core 39b. Each of the computers 110 is a generally independently functioning digital processor and is interconnected to the others by a plurality of interconnecting buses 120. The array 105 here may particularly be a SEAforth®-40C18 device sold under the trademark SEAforth® and for the sake of example, the following discussion proceeds on the basis.

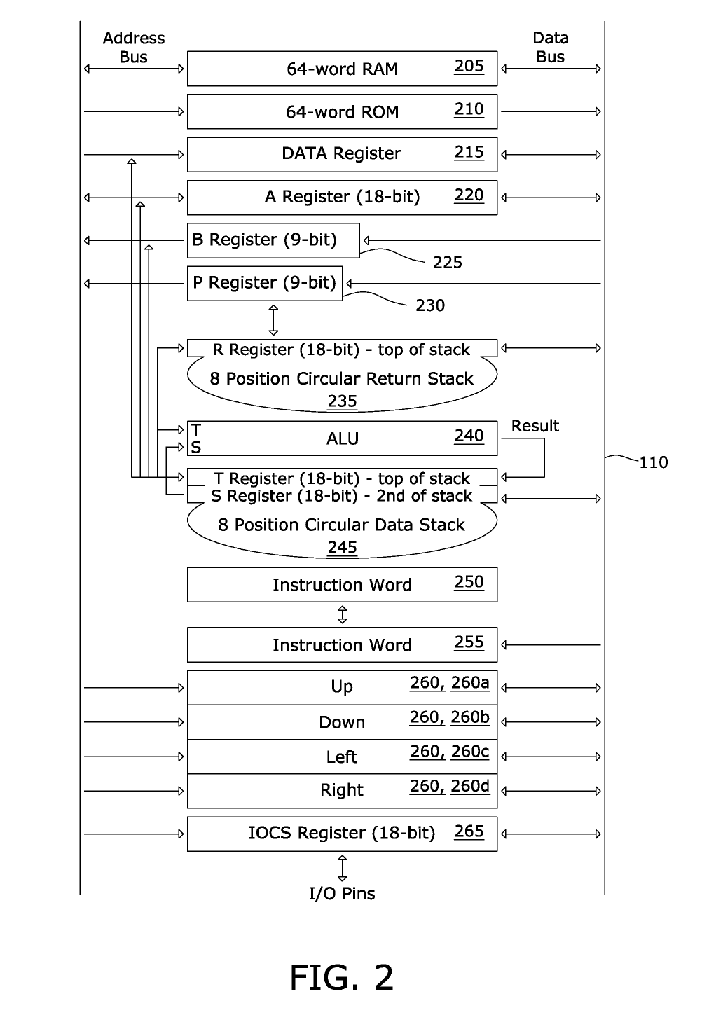

FIG. 2 is a diagrammatic view of the major internal features of a modified computer 110 in FIG. 1, according to one embodiment. Each of the computers is a generally and independently functioning digital processor, including a 64-word quantity of random access memory (RAM 205), a 64-word quantity of read only memory (ROM 210), an 18-bit data register (DATA-register 215), an 18-bit variable “A” register (A-register 220), a 9-bit variable “B” register (B-register 225), and a 10-bit program counter (P-register 230). Also included are a return stack 235 with top element of the return stack labeled R, an arithmetic and logic unit (ALU 240), and a data stack 245 with top element of the data stack labeled T and second element of the data stack labeled S. Each element that is a part of the return stack 235 and data stack 245 is an 18-bit register. Further included are an instruction decode logic 250, 18-bit instruction word register (I-register 255), four communication ports 260, which are individually designated as the up-port 260a, the down-port 260b, the left-port 260c, and the right-port 260d, and an 18-bit input/output control and status register (IOCS-register 265).

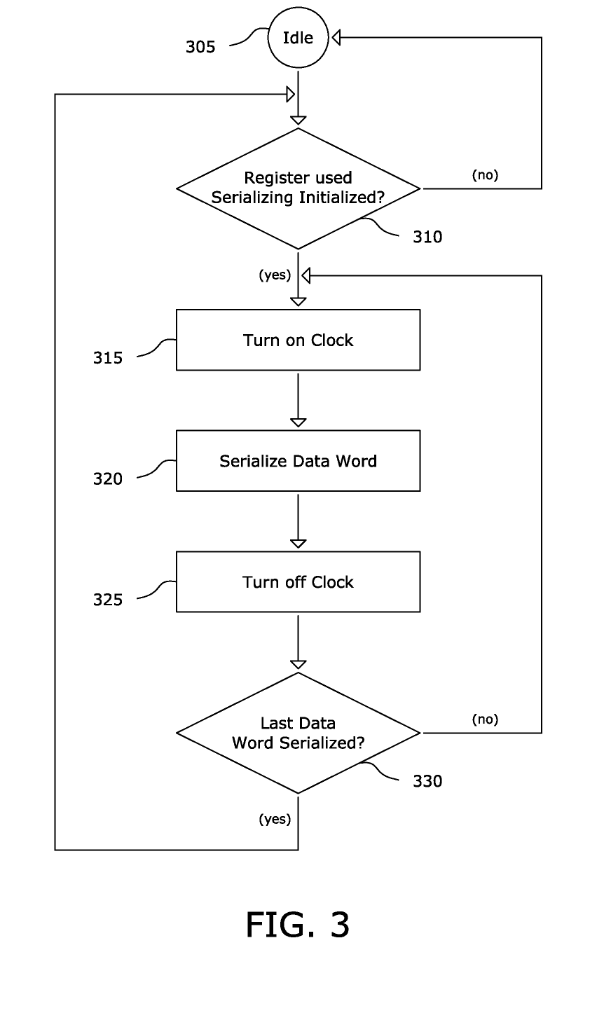

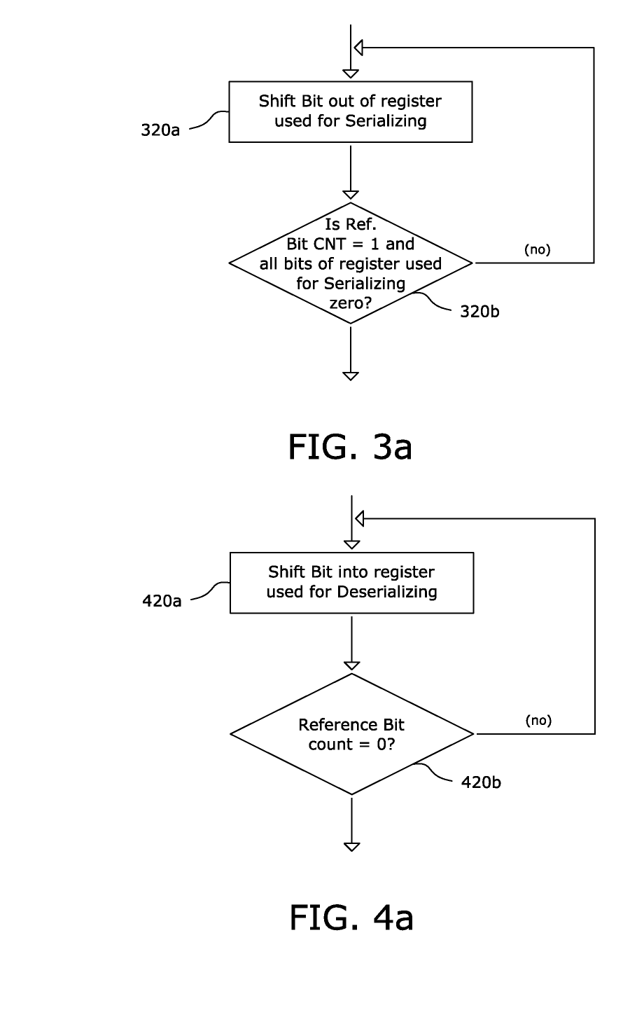

FIG. 3 is a flow chart describing the methodology used by the SERDES machine 100 for sending serial data according to one embodiment. In the power up condition, the state machine is in an idle state 305. In a step 310, the SERDES machine 100 verifies if the register used for serializing a data word has been initialized. If the register has been initialized, then in a step 310 the clock for serializing a data word is turned on. Otherwise, the SERDES machine 100 returns to the idle state 305. In a step 320, a data word is serialized. The methodology of serializing the data word is described in more detail in FIG. 3a. In a step 325, the clock for serializing a data word is turned off. In a step 330, the state machine verifies if the last data word has been serialized. If in a step 330, the last word has been serialized then the SERDES machine 100 returns to a step 310. Otherwise, the SERDES machine returns to a step 315.

FIG. 3a is a flow chart describing the detailed methodology of the SERDES machine 100 to control the operation of the step of serializing a data word bit by bit according to one embodiment. In a step 320a, a bit is serialized from the register used for serializing a data. In a step 320b, the reference bit count is compared to a value of one and all bits of the register used for serialization are checked for zero. If the reference bit count is one and all bits of the register used for serialization is zero, the data word is finished being serialized. Otherwise, the SERDES machine 100 returns to a step 320a and the next bit is serialized from the register used for serializing a data.

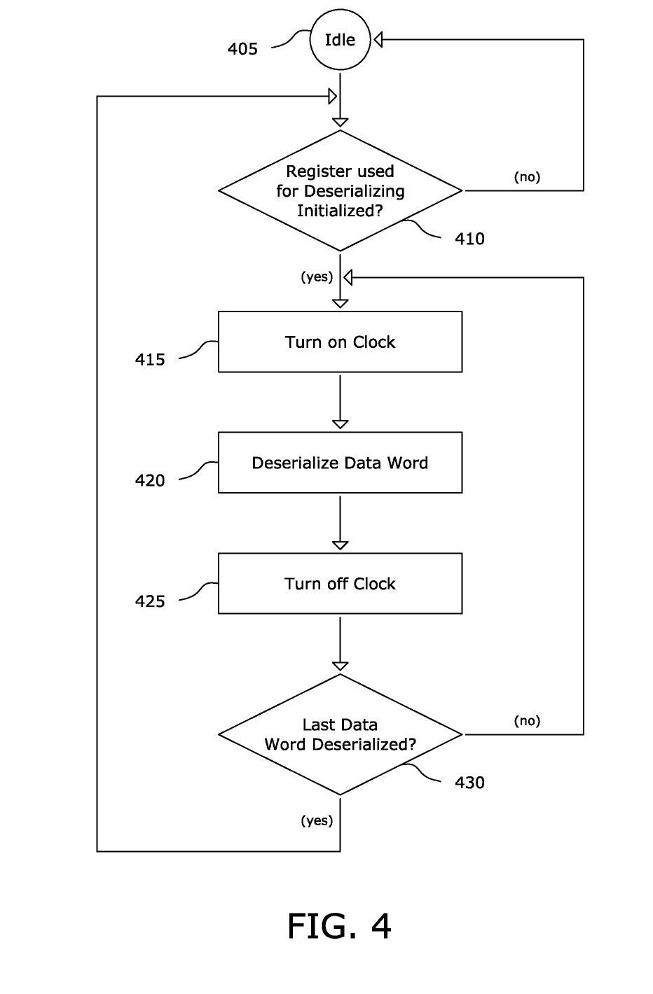

FIG. 4 is a flow chart describing the methodology used by the SERDES machine 100 for deserializing data according to one embodiment. In the power up condition, the SERDES machine 100 is in an idle state 405. In a step 410, the SERDES machine 100 verifies if the register for deserializing data has been initialized. If the register has been initialized, then in a step 415 the clock for deserializing data is turned on. Otherwise, the SERDES machine 100 returns to the idle state 405. In a step 420, a data word is deserialized bit by bit. The methodology of deserializing the data word is described in more detail in FIG. 4a. In a step 425, the state machine verifies if the last data word has been deserialized. If in a step 425 the last word has been deserialized, then the SERDES machine 100 returns to step 410. Otherwise, the SERDES machine 100 returns to a step 415.

FIG. 4a is a flow chart describing the detailed methodology of the SERDES machine 100 to control the operation of the step of deserializing a data word bit by bit, according to one embodiment. In a step 420a, a deserialized bit is shifted into the register used for deserializing a data word. In a step 420b, the reference bit count is compared to a value of zero. If the reference bit count is the value of zero, then the data word is finished being deserialized. Otherwise, the SERDES machine returns to step 420b and the next deserialized bit is shifted into the register used for deserializing a data word.

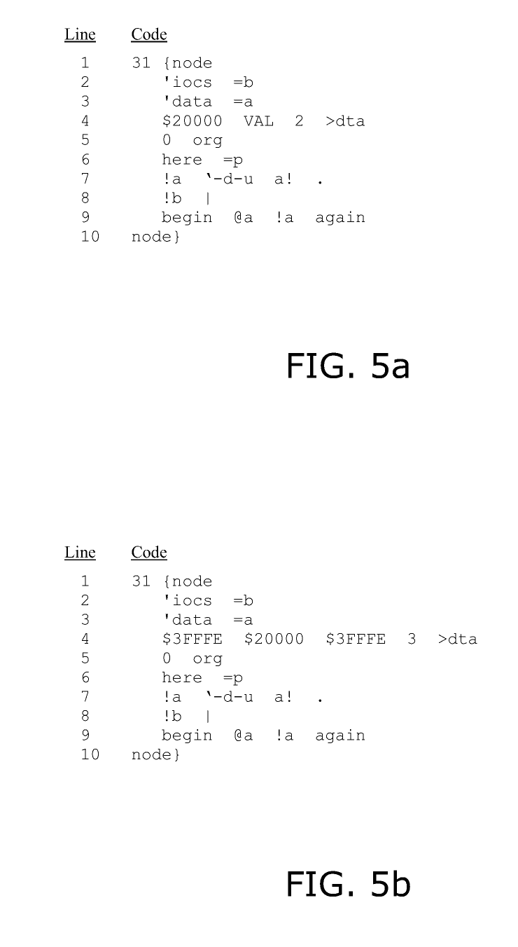

FIG. 5a is the native machine language and compiler directives written to instruct a processing device on the SEAforth® S40 array of processing devices for serializing data words, according to one embodiment. Line 1 of FIG. 5a shows the beginning of the definition for node 31b of FIG. 1. Line 2 loads the address of the IOCS register 265 of FIG. 2 into the A-register 220. Line 3 loads the address of the DATA register into the B-register 225. Both lines 2 and 3 initialize the contents of the A-register and B-register of node 31b prior to the execution of any instruction words in node 31b. Line 4 of FIG. 5a initializes top two registers of the data stack 245. The T-register is initialized with the value of VAL and the S-register with the value of $20000. Line 5 of FIG. 5a tells the compiler the location to compile the next operational codes. Line 6 puts the address of $000 in the program counter P-register 230. Line 6 puts the address of $000 in the program counter P-register 230 of node 31b. The program counter will address the location from which to fetch the first instruction word for execution in node 31b. Lines 7, 8, and 9 show the instructions and data positioned at the address $00000, $00001, $00002, and $00003 of the Random Access Memory (RAM) 205 of node 31b. Finally, line 10 ends the definition for node 31b.

Once node 31b receives the power, the first instruction word positioned at the address indicated by the program counter P-register 230 at a position $00000 of the RAM 205 will be fetched and positioned into the instruction decode logic 250 and the program counter P-register 230 is incremented to a value of $00001. The first instruction word loaded into instruction word register 255 contains the !a instruction (pronounced store a), @p+ instruction (pronounced fetch p plus), a! instruction (pronounced a store), and. instruction (pronounced no-operation or no-op). The second instruction word loaded into the instruction word register 255 contains the !b (pronounced store b) and three no-op instructions. The third instruction word loaded into the instruction word register 255 contains the @a instruction, !b instruction, jump instruction, and a corresponding jump to address for use in executing the jump instruction.

Each of the four instructions, as part of the first instruction word, will be executed in the following manner. The !a instruction will perform a write to the address contained in the A-register 220 and move the value $20000 from the S-register to the T-register. Hence, the value in the T-register VAL is written to the DATA register 215. This begins the process of using the SERDES to serialize data streams by initializing the DATA register 215. The @p+ instruction is compiled as a result of the written literal ‘-d-u and it fetches the contents at the address of the program counter and places that value into the T-register followed by an increment. Hence, the address of the up port 260a and down port 260b of node 31b are fetched from RAM 205 and placed into the T-register. The $20000 previously positioned in the T-register is now positioned in the S-register. The a! instruction fetches the value from the T-register (presently the address of the up port 260a and down port 260b) and replaces the address in the A-register. The no-op instruction completes the execution of the first instruction word.

Each of the four instructions, as part of the second instruction word, will be executed in the following manner. Recall that the execution of the first instruction word increments the address of the program counter P-register 230 to $00001 and the execution of the @p+ instruction increments the program counter again to $00002. Hence, the second instruction word is the word located at an address $00002 of RAM 405. The !b instruction will perform a write to the address contained in the B-register 225. Hence, the value $20000 is written to the IOCS register 265 and initiates the clock for the serialization process. The first data word to be serialized VAL is already located in the DATA register 215 and once the !b instruction is executed, all that is necessary to continue the serialization process is to provide a stream of data words. The remainder of the second instruction word is three no-ops.

Each of the four instructions, as part of the third instruction word, will be executed in the following manner. The @a instruction will fetch a data value that is to be serialized from the down port 260b. Recall that the A-register is addressing both the up port 260a and down port 260b of node 31b. However, in this example, node 21b to the south of node 31b is writing to its down port 260b and the up port 260a of node 31b is not being written. The data value is positioned in the T-register. The !a instruction will send the data value just fetched from the down port 260b to the up port. Again, even though the A-register is addressing both the up port 260a and down port 260b, a write will always send the data value to the up port 260a, because the down port 260b of node 21b and 31b is not being written. The write to the up port 260a takes place as soon as the first data word VAL has been serialized. A jump instruction is compiled as a result of the compiler directive AGAIN. The jump instruction returns instruction execution to the beginning of the present instruction word. Hence, the process of fetching from the down port 260b and writing to the up port 260a is repeated indefinitely. Not shown in FIG. 5a are the instructions to complete the serialization process, which include writing a value of $00000 to the IOCS register 265.

FIG. 5b is the native machine language and compiler directives written to instruct a processing device on the SEAforth® S40 array of processing for deserializing data words, according to one embodiment. Line 1 of FIG. 5b shows the beginning of the definition for node 31b of FIG. 3. Line 2 loads the address of the IOCS register 265 of FIG. 4 into the A-register 220. Line 3 loads the address of the DATA register 215 into the B-register 225. Both lines 2 and 3 initialize the contents of the A-register and B-register of node 31b prior to the execution of any instruction words in node 31b. Line 4 of FIG. 5b initializes the top three registers of the data stack 245. The T-register is initialized with the value of $3FFFE, the S-register with the value of $20000, and the register just below the S-register with the value of $3FFFE. Line 5 of FIG. 5b tells the compiler the location to compile the next operational codes. Line 6 puts the address of $000 in the program counter P-register 230 of node 31b. The program counter P-register 230 will address the location from which to fetch the first instruction word for execution in node 31b. Lines 7, 8, and 9 show the instructions positioned at the address $00000, $00001, $00002, and $00003 of the Random Access Memory (RAM) 205 of node 31. Finally, line 10 ends the definition for node 31b.

Once node 31b receives the power, the first instruction word positioned at the address indicated by the program counter at a position $00000 of the RAM 205 will be fetched and positioned into the instruction decode logic 250, and the program counter P-register 230 is incremented to a value of $00001. The first instruction word loaded into instruction word register 255 contains the !a instruction (pronounced store a), @p+ instruction (pronounced fetch p plus), a! instruction (pronounced a store), and. instruction (pronounced no-operation or no-op). The second instruction word loaded into the instruction word register 255 contains the !b (pronounced store b) and three no-op instructions. The third instruction word loaded into the instruction word register 255 contains the @a instruction, !b instruction, jump instruction, and a corresponding jump address for use in executing the jump instruction.

Each of the four instructions, as part of the first instruction word, will be executed in the following manner. The !a instruction will perform a write to the address contained in the A-register 220 followed by the value $20000 moving up from the S-register to the T-register and the value $3FFFE moves up from the first register below the S-register into the S-register. Hence, the value in the T-register $3FFFE is written to the DATA register 215. This begins the process of using the SERDES to serialize data streams by initializing the DATA register 215. The @p+ instruction is compiled as a result of the written literal ‘-d-u and it fetches the contents at the address of the program counter and places that value into the T-register followed by an increment. Hence, the address of the up port 260a and down port 260b of node 31b are fetched from RAM 205 and placed into the T-register. The $20000 previously positioned in the T-register is now positioned in the S-register and the $3FFFE previously positioned in the S-register is now positioned just below the S-register. The a! instruction fetches the value from the T-register (presently the address of the up port 260a and down port 260b) and replaces the address in the A-register 220. The $2000 moves up from the S-register to the T-register and the value $3FFFE moves up from the register below the S-register and into the S-register. The no-op instruction completes the execution of the first instruction word.

Each of the four instructions, as part of the second instruction word, will be executed in the following manner. Recall that the execution of the first instruction word increments the address of the program counter P-register 230 to $00001 and the execution of the @p+ instruction increments the program counter P-register 230 again to $00002. Hence, the second instruction word is the word located at an address $00002 of RAM 405. The !b instruction will perform a write to the address contained in the B-register 225. Hence, the value $20000 is written to the IOCS register 265 and initiates the clock for the SERDES serialization process. The value $3FFFE moves from the S-register to the T-register. The value $3FFFE remains at the top of the data stack in the T-register, and must remain at the top of the data stack counting in the 18 bits shifted in. The remainder of the second instruction word is three no-ops.

Each of the four instructions, as part of the third instruction word, will be executed in the following manner. The @a instruction will fetch the first deserialized data word from the up port 260a. Recall that the A-register 220 is addressing both the up port 260a and down port 260b of node 31b. However, in this example, node 21b to the South of node 31b is reading from its down port 260b and the up port 260a of node 31b is not being written. The data value fetched from the up port 260a of node 31b is positioned in the T-register. The !a instruction will send the data value just fetched from the up port 260a to the down port 260b of node 31b. Again, even though the A-register is addressing both the up port 260a and down port 260b, a write will always send the data value to the down port 260b because the down port 260b of node 31b is only ever written, and the down port of node 21b is only ever read from. A jump instruction is compiled as a result of the compiler directive again. The jump instruction returns instruction execution to the beginning of the present instruction word. Hence, the process of fetching from the up port 260a and writing to the down port 260b is repeated indefinitely. Not shown in FIG. 5b are the instructions to complete the serialization process, which include writing a value of $00000 to the IOCS register 265.

In an alternate embodiment, node 31b of FIG. 1 is operable to produce a serial data stream that is equivalent to a functional generator. The native machine language and compiler directives of FIG. 5a, written to instruct a processing device on the SEAforth®-S40C18 array of processing devices, are used to create functional output in the form of 18 bit data words.

In an alternate embodiment, node 31b of FIG. 1 is operable to execute the deserialized data words deserialized without passing the data words into the T-register first from the DATA register 215. The native machine language and compiler directives of FIG. 5b, written to instruct a processing device on the SEAforth®-S40C18 array of processing devices, are used to receive words to execute from the DATA register 215 accomplished by replacing lines 8 and 9 of FIG. 5b with !b ‘---u call.

The !b instruction is executed in the same way as is described in the description of FIG. 5b. The written literal ‘---u is executed in conjunction with the call instruction. The call instruction places the current P-register into the low 10 bits of the R-register. The next instruction word is fetched from the address determined by the literal ‘---u, hence the word's deserialized is executed in the up port 260a of node 31.

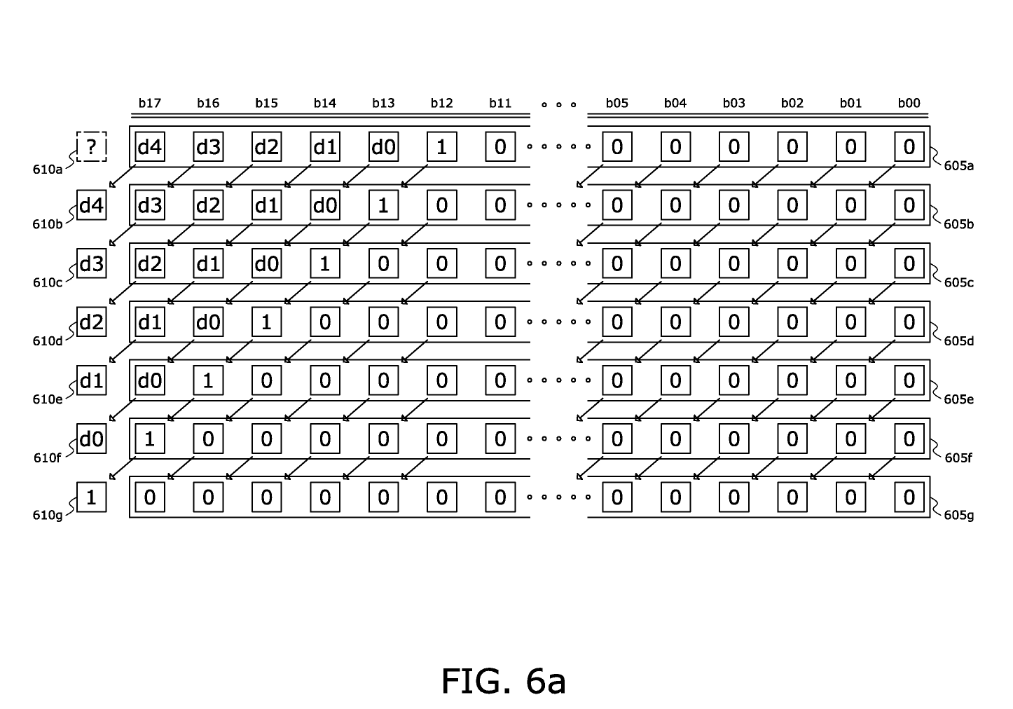

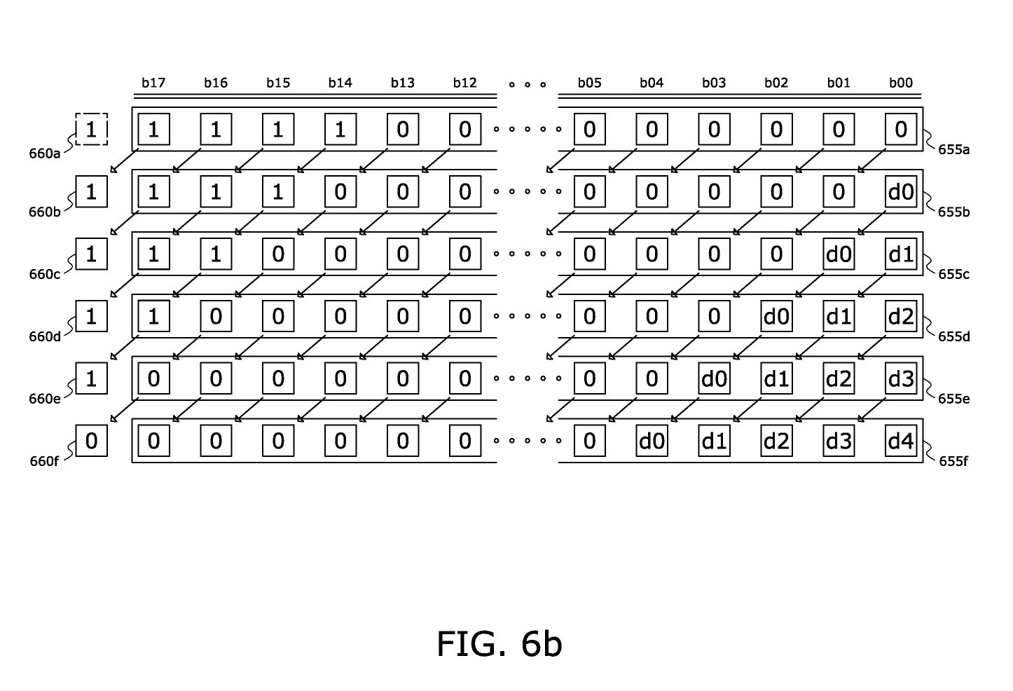

FIG. 6a illustrates several snapshots in time of a representative DATA register 215 of FIG. 2 in which the DATA register 215 is used for sending a 5 bit data word. Recall that when the register for serializing a data stream, the DATA register 215, is initialized with the first data to be serialized, as well as a bit position set to logic high representing the serialized word length if the serialized word length is less than 18 bits. A data word is completely serialized when all bits of the DATA register 415 are zero and a reference bit count contains a value of 1. Note that the serialized data word begins from the MSB of the data word. When serializing a one bit data word, bit b16 is set to one and bits b00-b15 are zero. When serializing a two bit data word, bit b15 is set to one and bits b00-b14 are zero. When serializing a three bit data word, bit b14 is set to one and bits b00-b13 are zero. The lone exception is for serializing an 18 bit data word, as all 18 significant bits fill the DATA register 415. In this example, a one fills the LSB of the DATA register 215 after the first bit is serialized, and for each of the remaining serialized bits in the DATA register 215, a zero fills the LSB.

Element 605a is the state of the DATA register 215 when it is initialized with a five bit data word followed by a one in the bit position b12. Hence, a five bit data word will be serialized. A reference bit count position 610 is used to indicate the completion of the serialized data word when the reference bit count position 610 is 1 and all bits of the DATA register 215 are zero. Element 405b is the state of the DATA register 215 after the first data bit d4 has been serialized. Each of the bits in the DATA register 215 are moved in the direction of the most significant bit (MSB), the MSB is moved into a reference bit count position 610b, and a zero fills the LSB. Element 605c is the state of the DATA register 215 after the second data bit d3 has been serialized. Again, each of the bits in the DATA register 215 are moved in the direction of the MSB, the MSB is moved into a reference bit count position 610c, and a zero fills the LSB. Element 605d is the state of the DATA register 215 after the third bit d2 has been serialized. Again, each of the bits in the DATA register 215 are moved in the direction of the MSB, the MSB is moved into a reference bit count position 610d, and a zero fills the LSB. Element 605e is the state of the DATA register 215 after the fourth bit d1 has been serialized. Again, each of the bits in the DATA register 215 are moved in the direction of the MSB, the MSB is moved into a reference bit count position 410e, and a zero fills the LSB. Element 605f is the state of the DATA register 215 after the fifth bit d0 has been serialized. Again, each of the bits in the DATA register 215 are moved in the direction of the MSB, the MSB is moved into a reference bit count position 610f, and a zero fills the LSB. Element 605g is the state of the DATA register 215 after all five bits have been serialized by the SERDES. A reference bit count position 610g has a value of one, and all bits of the DATA register 215 are zero. Hence, the process of serializing a data is word is complete.

FIG. 6b illustrates several snapshots in time of a representative DATA register 215 of FIG. 2 in which the DATA register 215 is used for receiving a serial data stream and converting it into an 18 bit data word. Recall that when the DATA register 215 is used for deserializing a data stream, the DATA register 215 is initialized with the value of $3FFFE and in terms of an 18 bit register, all bits are set except the least significant bit (LSB). When the LSB of DATA register 215 is the only bit initially set to zero, an 18 bit data word is deserialized. When the next LSB of the DATA register 215 is set to zero and the LSB of the DATA register 215 is set to zero, a 17 bit data word is deserialized. The bit length of the deserialized data word is based on the highest bit that is set to zero in the DATA register 215 prior to the deserialization of a data word.

Element 655a is the state of the DATA register 215 when it is initialized with the value $08000. Hence, the SERDES will deserialize a four bit data word. A reference bit count position 660a is used to indicate the completion of the deserialized data word. Element 655b is the state of the DATA register 215 after the first data bit d0 has been moved into the DATA register 215. Each of the bits in the DATA register 215 are moved in the direction of the most significant bit (MSB), the MSB is moved into a reference bit count position 660b, and the first deserialized bit d0 is moved into the LSB of the DATA register 215. Element 655c is the state of the DATA register 215 after the second data bit d1 has been moved into the DATA register 215. Again, each of the bits in the DATA register 215 are moved in the direction of the MSB, the MSB is moved into a reference bit count position 660c, and the second deserialized bit d1 is moved in the LSB of DATA register 215. Element 655d is the state of the DATA register 215 after the third data bit d2 has been moved into the DATA register 215. Again, each of the bits in the DATA register 215 are moved in the direction of the MSB, the MSB is moved into a reference bit count position 660d, and the third deserialized bit d2 is moved in the LSB of DATA register 215. Element 655e is the state of the DATA register 215 after the fourth data bit d3 has been moved into the DATA register 215. Again, each of the bits in the DATA register 215 are moved in the direction of the MSB, the MSB is moved into a reference bit count position 660e, and the fourth deserialized bit d3 is moved in the LSB of DATA register 215. Element 855f is the state of the DATA register 215 after the fifth data bit d4 has been moved into the DATA register 215. Again, each of the bits in the DATA register 215 are moved in the direction of the MSB, the MSB is moved into a reference data bit count position 660f, and the fifth deserialized bit d4 is moved in the LSB of DATA register 215. This completes the deserialization of the five bit data word when the reference bit count position contains a value of zero. The five bit data word is contained in the 18 bit DATA register 215. Recall that this register can be fetched from, or executed from. Hence, the five bits of the data word that were deserialized can make up data, instructions, or some combination thereof.

While various embodiments have been described above, it should be understood that they have been presented by way of example only, and that the breadth and scope of the invention should not be limited by any of the above described exemplary embodiments, but should instead be defined only in accordance with the following claims and their equivalents.

1) An apparatus for serialization of a transmitted data stream and deserialization of an incoming data stream: comprising an array of processors on a single chip wherein said system includes a parallel-distributed structure at the hardware level; and a plurality of substantially similar hardware portions disposed as an array on one microchip for serializing data.

2) An apparatus for serialization of a transmitted data stream and deserialization of an incoming data stream as in claim 1, wherein said substantially similar hardware portions are interconnected and communicate by single drop buses between adjacent neighboring hardware portions and there is no common bus for individually addressing the portions.

3) An apparatus for serialization of a transmitted data stream and deserialization of an incoming data stream as in claim 1, wherein the substantially similar hardware portions are computers, each having processing capabilities and at least some dedicated memory.

4) An apparatus for serialization of a transmitted data stream and deserialization of an incoming data stream as in claim 3, wherein said computers employ a dual-stack design, have individual ROM and RAM memory, and are adapted to execute instructions from a neighboring computer.

5) An apparatus for serialization of a transmitted data stream and deserialization of an incoming data stream as in claim 3, wherein said computers are further adapted to execute native FORTH language instructions and to use FORTH words, dictionaries of FORTH words, and forthlets.

6) An apparatus for serialization of a transmitted data stream and deserialization of an incoming data stream in a single chip computer system for deserializing wherein the system has a parallel-distributed structure at the hardware level comprising a plurality of substantially similar hardware portions disposed as an array on one microchip

7) An apparatus for serialization of a transmitted data stream and deserialization of an incoming data stream as in claim 6, wherein the substantially similar hardware portions are interconnected and communicate by single drop buses between adjacent neighboring hardware portions and there is no common bus for individually addressing the portions.

8) An apparatus for serialization of a transmitted data stream and deserialization of an incoming data stream as in claim 6, wherein the substantially similar hardware portions are computers, each having processing capabilities and at least some dedicated memory.

9) An apparatus for serialization of a transmitted data stream and deserialization of an incoming data stream as in claim 6, wherein the computers employ a dual-stack design, have individual ROM and RAM memory, and are adapted to execute instructions from a neighboring computer.

10) An apparatus for serialization of a transmitted data stream and deserialization of an incoming data stream as in claim 6, wherein the computers are further adapted to execute native FORTH language instructions and to use FORTH words, dictionaries of FORTH words, and forthlets.

11) An apparatus for serialization of a transmitted data stream and deserialization of an incoming data stream as in claim 6, wherein the deserialized data form instructions that are executed from the register used for deserializing the data words.

12) A method for performing the serialization of a data word comprising the steps of, initializing a register used for serialization, and serializing a most significant bit from said register, and moving all bits in the direction of the most significant bit, and replacing the least significant bit with a value of zero, and continuing said serializing, and moving steps are continued until a stopping condition is reached.

13) The method of claim 12, wherein, in said continuing step, the stopping condition includes a reference count bit position containing a value of one, and all bits zero in said register used for serializing.

14) The method of claim 12, wherein if an n bit data word is serialized from an n bit register, a value of one replaces the least significant bit when all bits are shifted in the direction of the most significant bit, only during said moving step in the first shift sequence.

15) A method for performing the deserialization of a data word comprising the steps of; initializing a register used for deserialization, and deserializing a bit, and positioning said bit in the least significant bit of the register, and moving all bits in the direction of the most significant bit, continuing said positioning and moving steps until a stopping condition is reached.

16) The method of claim 15, wherein said continuing step stopping condition includes a reference count bit position containing a value of zero.
